(19) United States
(12) Patent Application Publication
(10) Pub. No.: US 2006/0251076 A1
(43) Pub. Date: Nov. 9, 2006

(54) Real-time and reliable method for transporting data

(76) Inventors: Ching Hsiang Lee, Taipei City (TW); Chih Chiang Chou, Taipei City (TW); Hsiu Chung Wu, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/391,617

(22) Filed: Mar. 29, 2006

(30) Foreign Application Priority Data
Mar. 30, 2005 (TW) 094110117

(51) Int. Cl. H04L 12/56

(52) U.S. Cl. 370/392

(57) ABSTRACT

A method for transporting data is provided. The method can manage the buffer and communicate between a sender and a receiver by protocol to improve the performance of data transportation and real-time data playing. Moreover, the size of the buffer in the sender equals to that of the pre-buffer in the receiver, and the total amount of data held therefore is constant, thereby fixes the delay period to keep the real-time data played at a steady speed.

### BACKGROUND OF THE INVENTION

1. Field of the Invention

The present invention relates to a method for data transportation and, more particularly, to a real-time and reliable transportation method for audio and video data.

2. The Related Arts

Conventionally, the unreliable transportation protocols, such as UDP, are used in wired or wireless transportation of real-time audio or video data. Although the unreliable transportation protocols can meet the real-time demands, there is no effective compensation for data loss occurring during the transportation. Therefore, the audio and video quality at the receiving end is usually at the risk of being affected by the data loss. This is especially severe for wireless transportation where the environmental effects are important.

On the other hand, the reliable transportation protocols, such as TCP, usually use selective repeat to ensure the reliability of the transportation. However, the large amount of ACK/NAK packets slows down the data transportation speed.

Furthermore, the conventional buffer used in data transportation, when not appropriately managed, may cause long delays. This is especially obvious when the amount of transported data fluctuates.

Therefore, it is imperative to devise a real-time and reliable data transportation method for improving the transportation speed and reliability of the real-time data so that the data playback is steady.

### SUMMARY OF THE INVENTION

The present invention has been provided to overcome the aforementioned drawbacks of the conventional real-time data transportation method. The primary objective of the present invention is to provide a real-time and reliable data transportation method, through buffer management and protocol between a transmitting end and a receiving end, to improve the efficiency of real-time data transportation and playback.

Preferably, the buffer at the transmitting end and the reserved buffer at the receiving end are of equal size so that the transmitting buffer and the reserved receiving buffer can hold the same amount of data to maintain a fixed delay for a steady playback of the real-time data.

The real-time reliable data transportation method of the present invention is applicable to both wired and wireless network. During data transportation, a sliding window and a selective repeat method are employed to transmit and receive data. Re-sending of lost data avoids the drawbacks of conventional unreliable transportation method without the waste of bandwidth.

Another objective of the present invention is to provide an aggregated ACK/NAK method to reduce the number of small packets to improve data transportation speed.

The real-time and reliable data transportation method in accordance with the present invention, applicable to both wired and wireless networks, can also be used with various layers of network communication protocols, such as UDP, and IP. Furthermore, data can be transported within the set delay so that the quality of audio and video playback is not affected. The present invention provides the advantages of reduction in amount of resent lost packets, improvement in data transportation speed, and efficiency in network bandwidth utilization.

These and other objectives, features, and advantages of the invention will be apparent to those skilled in the art, from a reading of the following brief description of the drawings, the detailed description of the preferred embodiment, and the appended claims.

### BRIEF DESCRIPTION OF THE DRAWINGS

The present invention can be understood in more detail by reading the subsequent detailed description in conjunction with the examples and references made to the accompanying drawings, wherein:

FIG. 1 is a flowchart of a transmitting data management method in accordance with a first embodiment of the present invention;

FIG. 2 is a flowchart of a receiving data management method in accordance with a second embodiment of the present invention;

FIG. 3 is a flowchart of a playback data management method in accordance with a third embodiment of the present invention;

FIG. 4 is a flowchart of a receiving end data management method in accordance with a fourth embodiment of the present invention;

FIG. 5 is a flowchart of a transmitting end data management method in accordance with a fifth embodiment of the present invention;

FIG. 6 is a schematic view of format of an aggregated ACK/NAK packet; and

FIG. 7 is a schematic view of a system embodying the present invention.

### DETAILED DESCRIPTION OF THE BEST MODE FOR CARRYING OUT THE PRESENT INVENTION

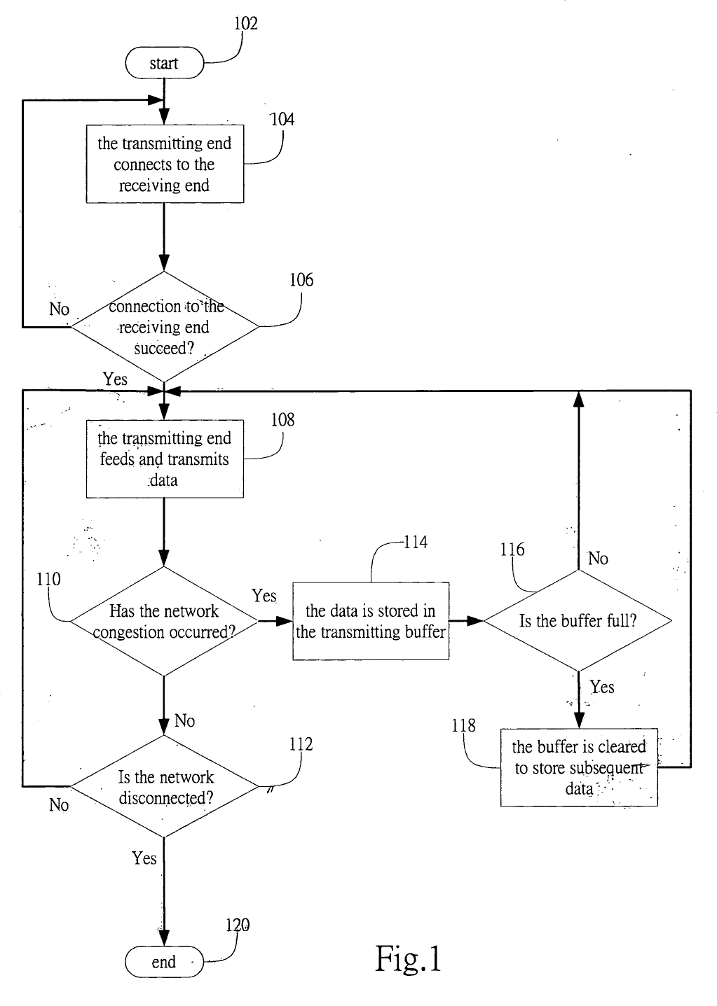

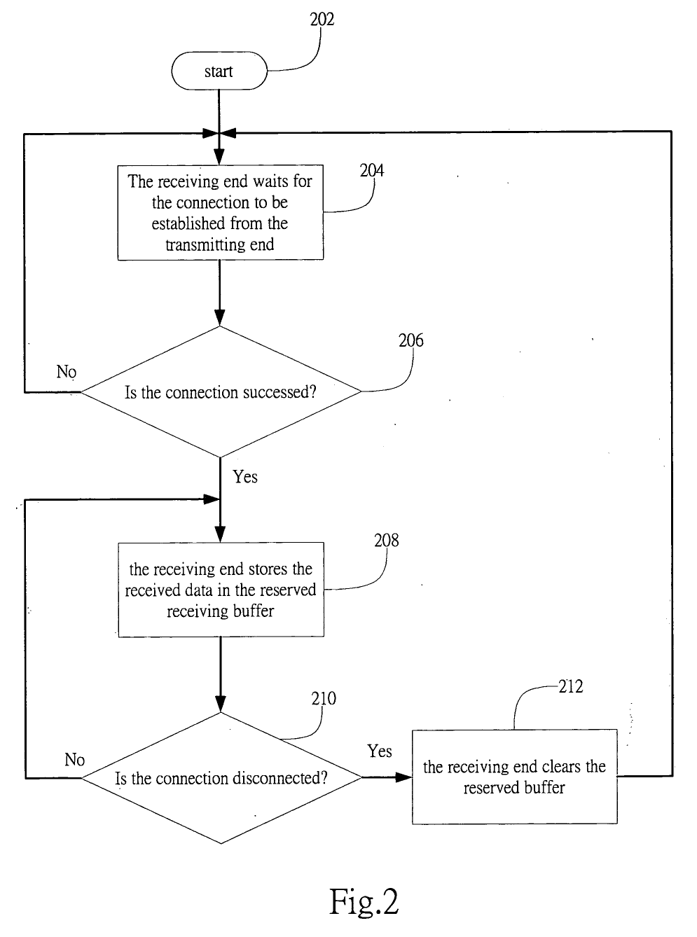

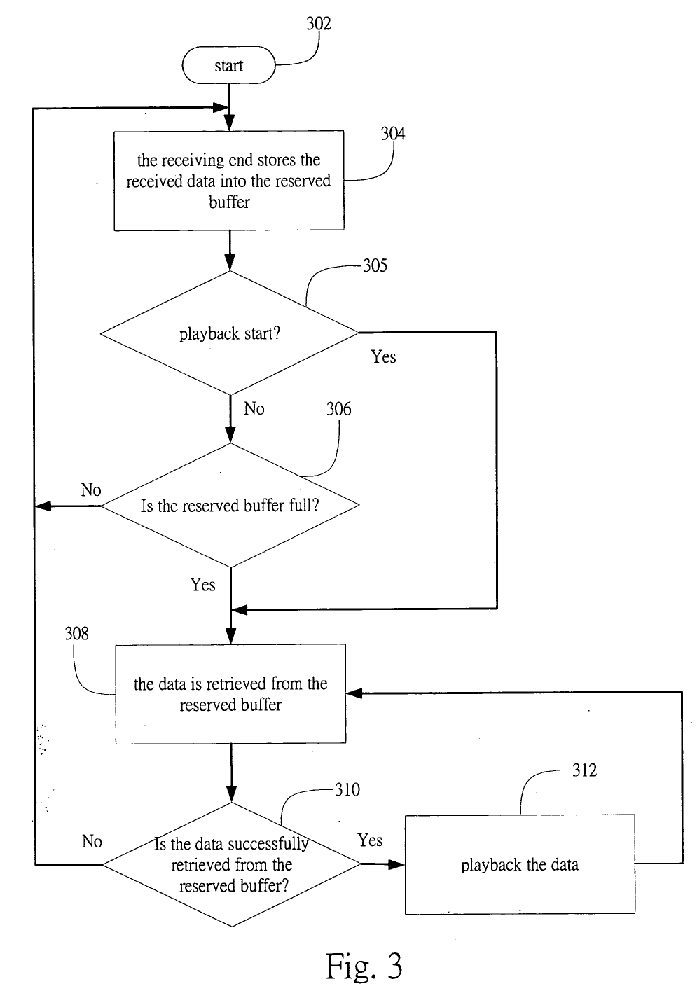

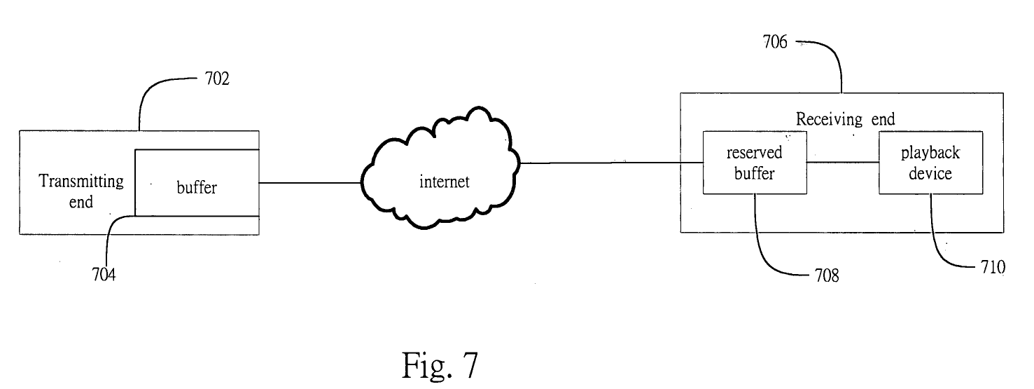

With reference to the drawings and in particular to FIG. 7, which shows a schematic view of a system embodying the present invention, the system comprises a transmitting end 702 having a buffer 704 that sends real-time data through Internet to a receiving end 706 having a reserved buffer 708 and a playback device 710. The transmitting end 702 uses the buffer 704 to manage transmitted data, as shown in FIG. 1; the receiving end 706 uses the reserved buffer 708 to manage received data, as shown in FIG. 2; the receiving end 706 also uses the reserved buffer 708 to manage playback data, as shown in FIG. 3; and the transmitting end 702 and the receiving end 706 communicate through a communication protocol to manage the transmitting and receiving of data.

Preferably, the transmitting buffer and the receiving buffer are of the same size, for example, data capacity for 1 second playback. After the transmitting end and receiving end are connected, the playback device can start playback when the reserved buffer at the receiving end is full. When the data transportation is smooth, the reserved receiving buffer stays full. When the data transportation between the transmitting end and the receiving end is interrupted, the data accumulation rate of the transmitting buffer and the data consumption rate of the reserved receiving buffer is the same so that the total amount of the data in the transmitting buffer and the reserved receiving buffer stays constant, which is equal to the data capacity of the reserved receiving buffer. If the connection is interrupted longer than a predetermined duration, for example, 1 second, so that the reserved receiving buffer is empty and the transmitting buffer is full, the transmitting buffer is cleared in order to store data. In other words, only when the connection is interrupted for longer than the time to play back the entire buffer data, such as 1 second, the buffer will be emptied. If the disconnection continues, the buffer data is cleared periodically until the connection resumes. In this manner, the delay in the playback stays fixed to be the time to play the data in the entire buffer. However, the disconnection in the network is usually short, such as 1 second, the buffer capacity can be configured to be the data size that can be played in the usual interruption duration of the network.

FIG. 1 shows a flowchart of a transmitting data management method in accordance with a first embodiment of the present invention. The method starts with step 102. In step 104, the transmitting end connects to the receiving end. The transmitting end determines whether the connection to the receiving end succeeds by a response from the receiving end, as in step 106. If the connection is unsuccessful, the transmitting end will repeat step 104 until the connection is established. Once the connection is successful, the transmitting end feeds and transmits data, as shown in step 108. During the transmission, the transmitting end continues to monitor the network communication to determine whether congestion has occurred, as in step 110. If there is congestion, the data is stored in the transmitting buffer (step 114) to wait for later transmitting. In the mean time, the transmitting end continues to monitor the buffer and determines whether the buffer is full (step 116). If the buffer is full, the buffer is cleared to store subsequent data (step 118). The transmitting end continues to monitor whether the network is disconnected (step 112), and repeats the steps 102-112 until the connection interrupted. Then, the connection is re-established or finished (step 120).

FIG. 2 shows a flowchart of a receiving data management method in accordance with a second embodiment of the present invention. The method starts with step 202. The receiving end waits for the connection to be established from the transmitting end (step 204), and continues to monitor and determines whether the connection is successful (step 206). The receiving end waits until the connection is successful. Once the connection is established, the receiving end stores the received data in the reserved receiving buffer (step 208). During the receiving period, the receiving end continues to monitor the network communication, as in step 210. If the connection continues, the subsequently received data is stored in the reserved buffer; otherwise, the receiving end clears the reserved buffer (step 212) and waits for re-connection.

FIG. 3 shows a flowchart of a playback data management method in accordance with a third embodiment of the present invention. The method starts with step 302. In step 304, the receiving end stores the received data into the reserved buffer, and continues to monitor whether the reserved buffer is full. Step 305 is to determine whether the playback starts. If not, determines whether the reserved buffer is full (step 306). If the reserved buffer is not full, the receiving end continues to store the received data into the reserved buffer. If the reserved buffer is full or the playback has already started, the data is retrieved from the reserved buffer (step 308). Step 310 is to determine whether the data is successfully retrieved from the reserved buffer. If so, the playback device starts to play the data (step 312); otherwise, the receiving end returns to step 304 to store the received data into the reserved buffer.

In the above data management during the transmitting and receiving, a sliding window and a selective repeat method are used to transmit and receive data. The data transmitting and receiving can also be conducted in a wireless network.

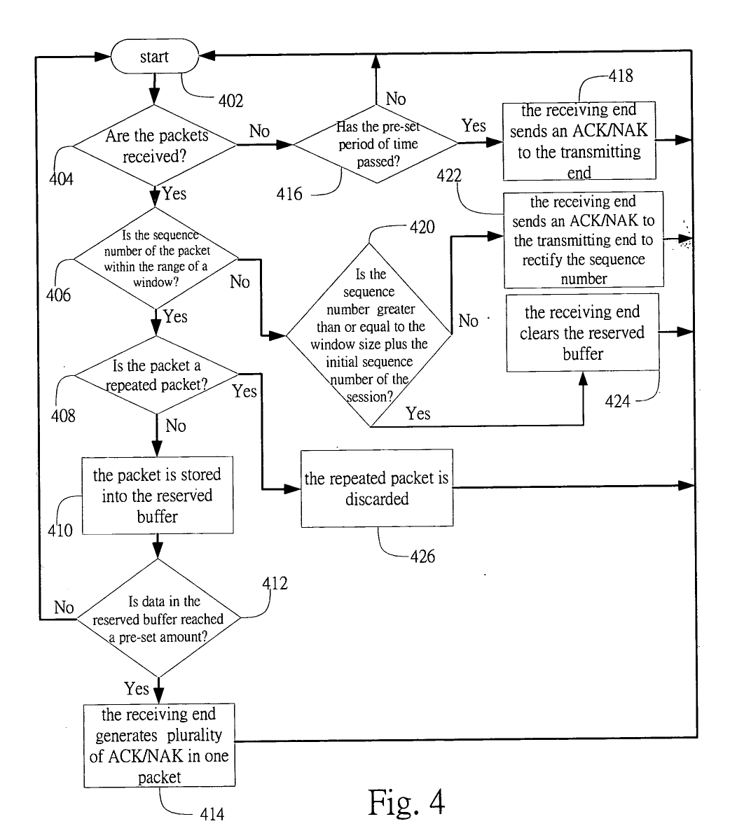

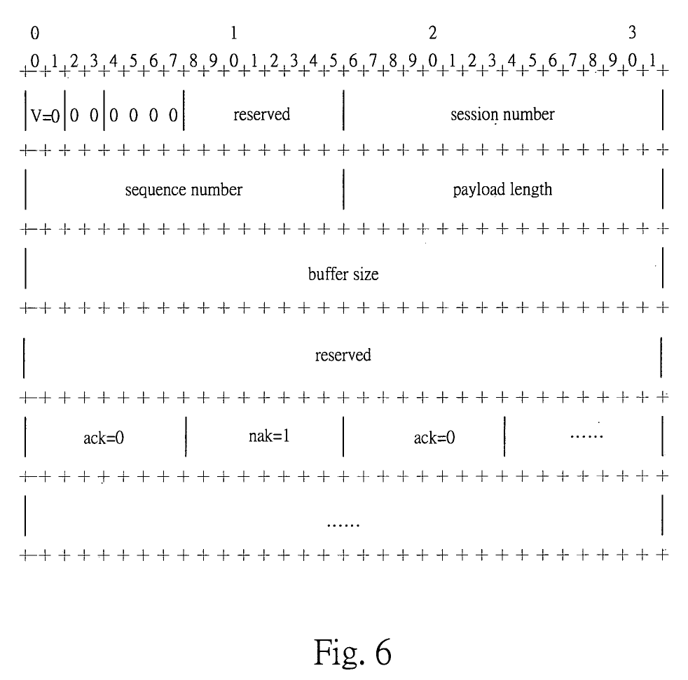

FIG. 4 shows a flowchart of a data management method at the receiving end. The method starts with step 402. In step 404, the receiving end determines whether packets are received. If not, the receiving end determines whether a pre-set duration has passed (step 416). If the pre-set period of time has passed since the last received packet, the receiving end sends an ACK/NAK (acknowledgement) to the transmitting end (step 418). If the packets are received, the receiving end determines if the sequence number of the packet is within the range of a window (step 406). If the sequence number is not within the window range, the receiving end further determines whether the sequence number is greater than or equal to the window size (step 420). If so, the receiving end clears the reserved buffer (step 424); otherwise, the receiving end sends an ACK/NAK to the transmitting end to rectify the sequence number (step 422). If the sequence number is within the window range, the sequence number is used to determine whether the packet is a repeated packet (step 408). If so, the repeated packet is discarded (step 426); otherwise, the packet is stored into the reserved buffer (step 410). In step 412, the receiving end determines whether the data in the reserved buffer reaches a pre-set amount. If so, the receiving end generates a report packet having a plurality of ACK/NAK fields (step 414). The aggregated ACK/NAK packet can reduce the number of the ACK/NAK packets and increase the data transportation speed. FIG. 6 shows the format of the aggregated packet.

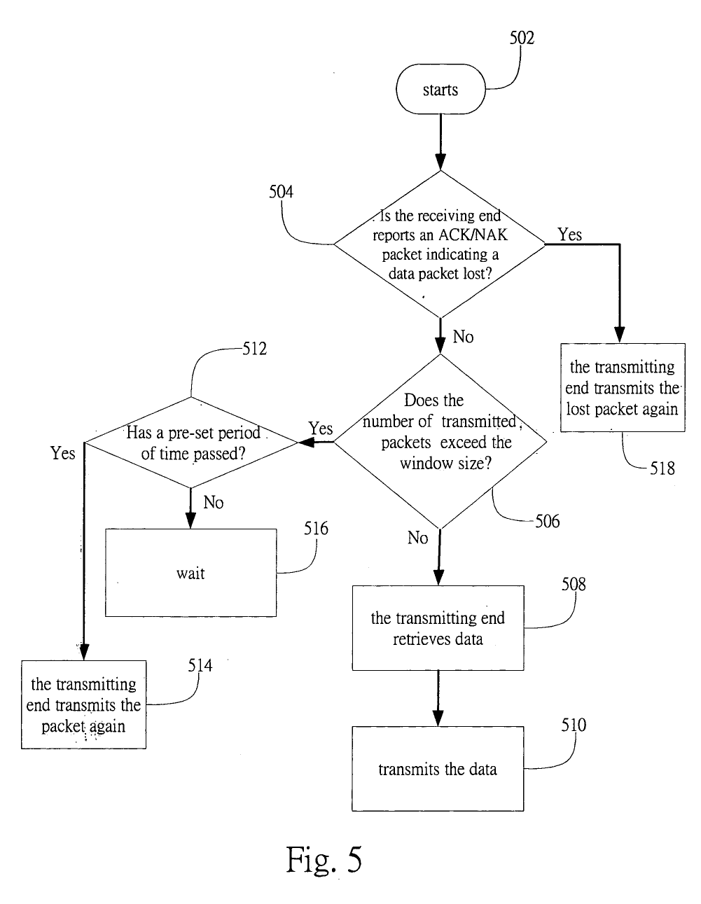

FIG. 5 shows a flowchart of a data management method at the transmitting end. The method starts with step 502. When the receiving end reports an ACK/NAK packet indicating a data packet is lost (step 504), the transmitting end transmits the lost packet again (step 518). Otherwise, the transmitting end determines whether the receiving end can further receive data in the window by checking the report packet from the receiving end (step 506). If the receiving end can further receive data packets, the transmitting end retrieves data (step 508), and transmits the data (step 510). If not, the transmitting end determines whether a pre-set period of time has passed (step 512). If not, the transmitting end continues to wait until the pre-set period of time has expired (step 516). Otherwise, the transmitting end transmits the packet again (step 514).

While the invention has been described in connection with what is presently considered to the best modes, it is to be understood that the invention is not to be limited to the disclosed modes, but on the contrary, is intended to cover various modifications and equivalent arrangement included within the spirit and scope of the appended claims.

What is claimed is:

1. A method for real-time and reliable data transportation, comprising the steps of:
transmitting data management, for a transmitting end to utilize a buffer to manage data for transmitting;
receiving data management, for a receiving end to utilize a reserved buffer to manage received data;
playback data management, for the receiving end to utilize the reserved buffer to manage received data for playback; and
data management communication, for the transmitting end and the receiving end to use a communication protocol to cooperatively manage transmitting and receiving data.

2. The method as claimed in claim 1, wherein, further comprising:
configuring the buffer at the transmitting end and the reserved buffer at the receiving end to have the same capacity;
maintaining data consumption rate in the reserved buffer at the receiving end equal to data filling rate in the buffer at the transmitting end; and
clearing the buffer at the transmitting end if the connection between the transmitting end and the receiving end exceed the time to play the data mount in the reserved buffer at the receiving end.

3. The method as claimed in claim 1, wherein the transmitting data management step further comprising the steps of:
the transmitting end establishing connection to the receiving end;
determining whether the connection is successful, and if so, feeding and transmitting data;
determining whether network congestion occurs, and if so, storing data into the buffer;
determining whether the buffer is full, and if so, clearing the buffer; and
determining whether the connection is interrupted, and if so, re-establishing connection or finishing.

4. The method as claimed in claim 1, wherein the receiving data management step further comprising the steps of:
the receiving end waiting for connection from the transmitting end and monitoring whether the connection is successful, and waiting until the connection is successful;
storing received data into the reserved buffer;
determining whether the connection continues, and if so, storing received data into the reserved buffer; and
clearing the reserved buffer when the connection is interrupted.

5. The method as claimed in claim 1, wherein the playback data management step further comprising the steps of:
the receiving end storing received data to the reserved buffer;
determining whether playback already starts; and if not, determining whether the reserved buffer is full; and if not full, continuing to store received data into the reserved buffer;
retrieving data from the reserved buffer if playback starts or the reserved buffer is full; and
determining whether the data retrieval is successful, and if so, playing the retrieved data, otherwise, waiting for the receiving end to store received data into the reserved buffer.

6. The method as claimed in claim 1, wherein the data communication step utilizes a sliding window and selective repeat to transmit and receive data packets.

7. The method as claimed in claim 6, wherein the data communication step utilizes the sliding window and the selective repeat in a wireless network to transmit and receive data packets.

8. A method for real-time and reliable data transportation, wherein when a transmitting end does not send data for exceeding a pre-set period of time, a receiving end re-sends an ACK/NAK packet to the transmitting end to report the time expiration.

9. A method for real-time and reliable data transportation, wherein a transmitting end transmits a packet with an abnormal sequence number to a receiving end to indicate the receiving end to clear a reserved buffer at the receiving end.

10. The method as claimed in claim 9, wherein the abnormal sequence number is greater than or equal to a window size.

11. The method as claimed in claim 9 further comprising the steps of:
checking whether a packet is repeated, for the receiving end to use the sequence number of the packet that is repeated; and
discarding the repeated packet.

12. A method for real-time and reliable data transportation, wherein a receiving end aggregating acknowledgements to a transmitting end during the data transportation, the method comprising the steps of:
the receiving end generating a report packet, having a plurality of fields, each field indicating an acknowledgement; and
the receiving end sending the report packet to the transmitting end.

13. A method for real-time and reliable data transportation, comprising the steps of:
a transmitting end transmitting a data packet to a receiving end when the transmitting end receives an report packet (ACK/NAK) from the receiving end indicating that the data packet is lost; and
the transmitting end determining whether the receiving end is able to receive further data packets and how many to receive by checking the window size in the report packet.

14. The method as claimed in claim 13, wherein when the transmitting end determines by the window size in the report packet that the receiving end is unable to receive data, and exceeding a pre-set period of time, the transmitting end transmits a retried packet to the receiving end.
